(19) United States
(12) Patent Application Publication
(10) Pub. No.: US 2012/0079462 A1
(43) Pub. Date: Mar. 29, 2012

(54) SYSTEMS AND METHODS OF SOURCE SOFTWARE CODE OBFUSCATION

(75) Inventor: Paul Marion Hriljac, Prescott, AZ (US)

(73) Assignee: SoftKrypt LLC

(21) Appl. No.: 13/019,079

(22) Filed: Feb. 1, 2011

Related U.S. Application Data
(60) Provisional application No. 61/386,311, filed on Sep. 24, 2010.

(51) Int. Cl. G06F 9/45

(52) U.S. Cl. 717/136

(57) ABSTRACT

One or more selected portions of computer-executable instructions stored on non-transient storage media of a computer system are modified according to a method. In various embodiments, the method includes any one or combination of: (1) applying, with a processor of the computer system, a data transformation to one or more value representations in the computer-executable instructions to create one or more transformed code segments, the data transformation comprising at least one of a nonlinear transformation and a function composition transformation; (2) generating, with a processor of the computer system, transformed computer-executable instructions based on the transformed code segments; and (3) storing the one or more transformed code segments with corresponding computer-executable instructions on the non-transient storage media.

### CROSS-REFERENCE TO RELATED PATENT APPLICATIONS

This application claims priority from Provisional Application U.S. Application 61/386,311, filed Sep. 24, 2010, incorporated herein by reference in its entirety.

### BACKGROUND

1. Field of the Invention

Embodiments of the present invention relate generally to system and processes for prevention of reverse engineering, security of data and software programs, distributable content in hostile environments, and in particular embodiments, to systems and processes for the protection of distributed or distributable software from hostile attacks or piracy, such as automated attacks, tampering, or other unauthorized use.

2. Related Art

Commercial vendors may distribute sensitive software-based content on physically insecure systems and/or to devices. For example, content distribution for multi-media applications may involve electronic dissemination of books, music, software programs, and video over a network. In particular, software is often distributed over the Internet to servers for which access control enforcement cannot be guaranteed, as the server sites may be beyond the control of the distributor. Nonetheless, such Internet-based software distribution often requires management and enforcement of digital rights of the distributed content. However, the distributed content may be prone to different kinds of attacks, including a direct attack by an otherwise legitimate end user and an indirect attack by a remote hacker or an automated attack, employing various software tools. Often copy protection processes can be employed to inhibit hackers from altering or bypassing digital rights management policies for content protection.

Vendors frequently install software on platforms that are remotely deployed and not controllable or even viewable by ordinary means. For instance, navigation or communications software may be deployed on vehicles or devices that cannot be retrieved. Entertainment applications may be installed on hand held devices that will never be returned to the provider. Control and monitoring software may be installed on medical devices that are implanted in medical patients and cannot be retrieved. The manufacturers of these types of software may wish to limit the use or reuse of their products. For example, they may wish to introduce geofencing or temporal fencing to their software, so that the use of that software is controlled based on the geographic location where the platform is located, or to impose a duration after which the software will not operate. They may wish to limit the use of a particular copy of their software so that it can only be used by one device. They may wish to limit the use of a particular copy of their software so that it can only be used by one licensed user.

Software is frequently written for different levels of use depending on various conditions. For example, some computer games have features that are meant to be used only from certain defined users. Many software vendors have moved to a “freemium” marketing approach, in which their programs have versions that are available for all users but other versions are only available to licensed users. Creating software that has these types of controls and preventing the override of these controls can be an important consideration. Accordingly, it may be desirable to protect, software code from automated programs that may ascertain the data flow in the compiled code using tools such as static analysis or run-time trace analysis tools.

Software, being information, is generally easy to modify. Tamper-resistant software also can be modified, but the distinguishing characteristic is that it is difficult to modify tamper-resistant software in a meaningful way. Often attackers wish to retain the bulk of functionality, such as decrypting protected content, but avoid payment or modify digital rights management portions. Accordingly, in certain tamper-resistant software, it is not easy to observe and analyze the software to discover the point where a particular function is performed, or how to change the software so that the desired code is changed without disabling the portion that has the functionality the attacker wishes to retain.

In order to avoid wholesale replacement of the software, for example, the software may contain and protect a secret. This secret might be simply how to decode information in a complex, unpublished, proprietary encoding, or it might be a cryptographic key for a standard cipher. However, in the latter case, the resulting security is often limited by the ability of the software to protect the integrity of its cryptographic operations and confidentiality of its data values, which is usually much weaker than the cryptographic strength of the cipher. Indeed, many attempts to provide security simply by using cryptography fail because the software is run in a hostile environment that fails to provide a trusted computing base. Such a base may be required for cryptography to be secure and can be established by non-cryptographic means (though cryptography may be used to extend the boundaries of an existing trusted computing base).

### SUMMARY OF THE DISCLOSURE

Various embodiments of the present invention provide a method and system for increasing security of a computer program by obfuscation of portions of the computer-executable instructions. The mathematical procedure of coordinate change may be applied to value representations in the computer-executable instructions. For example, variables, parameters, and/or constants containing sensitive data may be among the value representations that are changed. This coordinate change may be implemented using a nonlinear transformation or a composition of transformations. The value representations in the computer-executable instructions may then be replaced with the transformed code segments that correspond with the coordinate change.

Various embodiments of the present invention may prevent the rewritten code from being easily reverse-engineered or analyzed. Some embodiments may be implemented so as to produce rewritten code allowing a variety of controls and authorization capabilities for securing distributable content in hostile or unknown environments. As an example, use of transformed code together with calls to external variables that are intrinsically interlinked may protect distributable software from automated attacks. In some embodiments, computer systems running pre-compiler software may dynamically introduce operators from the source code for applying data transformation based on custom criteria for interacting with data, control systems, hardware, sensitive or valuable equipment with the use of this resulting tamper-resistant object code.

Various embodiments of the present invention may provide a method for modifying one or more selected portions of computer-executable instructions stored on non-transient storage media of a computer system, the method may include, but is not limited to, any one or combination of: (1) applying, with a processor of the computer system, a data transformation to one or more value representations in the computer-executable instructions to create one or more transformed code segments, the data transformation comprising at least one of a nonlinear transformation and a function composition transformation; (2) generating, with a processor of the computer system, transformed computer-executable instructions based on the transformed code segments; and (3) storing the one or more transformed code segments with corresponding computer-executable instructions on the non-transient storage media.

In some embodiments, the transformed computer-executable instructions may be generated by the processor of the computer system. In some embodiments, the data transformation may comprise a nonlinear transformation. In other embodiments, the data transformation may comprise a function composition transformation. Some embodiments may further include selecting, with a processor of the computer system, the one or more value representations. In some embodiments, selecting the one or more value representations may comprise analyzing, with the processor of the computer system, the computer-executable instructions to determine the one or more value representations. In some embodiments, the data transformation may further comprise reversing the data transformation in one or more of the transformed code segments by applying an inverse transformation of the data transformation. In some embodiments, the function composition transformation may be automorphic. In some embodiments, the function composition transformation may comprise at least one nonlinear function and at least two linear functions, and a number of the at least two linear functions may be at least one more than a number of the at least one nonlinear functions.

Various embodiments of the present invention may provide a system for modifying one or more selected portions of computer-executable instructions. The system may include, but is not limited to: (1) a storage medium for storing computer-executable instructions, and (2) a processor configured to apply a data transformations that can be applied to source code segments, the data transformation comprising at least one of a nonlinear transformation and a function composition transformation; (2) a processor configured to apply a data transformation to one or more value representations in the computer-executable instructions to create transformed source code segments, the data transformation comprising at least one of a nonlinear transformation and a function composition transformation; the processor further configured to create transformed computer-executable instructions based on the transformed source code segments; the processor further configured to store the transformed computer-executable instructions on a storage medium.

In some embodiments, one processor may be used, while in other embodiments, more than one processor may be used to provide the operations and functions described herein. In some embodiments, the transformed computer-executable instructions and the computer-executable instructions may be stored in the same storage medium. In some embodiments, the data transformation may include, but is not limited to, a nonlinear transformation. In other embodiments, the data transformation may include, but is not limited to, a function composition transformation. In some embodiments, a processor may be configured to select the one or more value representations. In some embodiments, a processor may be configured to generate an inverse transformation of the data transformation the processor configured to apply the inverse transformation to one or more value representations in the computer-executable instructions to create inversely transformed source code segments. In some embodiments, the function composition transformation may be automorphic. In some embodiments, the function composition transformation may include, but is not limited to, one more linear functions than the number of nonlinear functions.

Various embodiments of the present invention provide a method for modifying one or more portions of data stored on non-transient storage media of a computer system, the method may include, but is not limited to: (1) generating, with a processor of the computer system, a data transformation to the one or more portions of data to create one or more transformed data segments, the data transformation comprising at least one of a nonlinear transformation and a function composition transformation; (2) creating, with the processor of the computer system, transformed data based on the transformed data segments; and (3) storing the transformed data on the non-transient storage media.

Various embodiments of the present system provide a system for executing a modified set of computer-executable instructions stored on non-transient storage media of a computer system, the system comprising: a storage medium that contains the computer-executable instructions; and a processor configured to execute the computer-executable instructions; wherein the computer-executable instructions have been modified by a data transformation to one or more value representations in the computer-executable instructions; wherein the data transformation comprised at least one of a nonlinear transformation and a function composition transformation.

### BRIEF DESCRIPTION OF THE DRAWINGS

FIG. 1 illustrates a computer system for implementing a method of modifying data in accordance with the present invention;

FIG. 2 is a flow diagram for blackening code, in accordance with an embodiment of the present invention;

FIG. 3A illustrates sample code, before blackening;

FIG. 3B illustrates the sample code of FIG. 3A, after blackening, in accordance with an embodiment of the present invention;

FIG. 4A is a schematic depiction of an example use of an obfuscation method, in accordance with an embodiment of the present invention that inserts a decision point that invokes functions;

FIG. 4B is a schematic depiction of an example use of an obfuscation method, in accordance with an embodiment of the present invention that inserts decision points that invoke functions and process calls;

FIG. 5A is a schematic depiction of an example use of an obfuscation method in accordance with an embodiment of the present invention, which illustrates a result when correct input is given;

FIG. 5B is a schematic depiction of an example use of an obfuscation method in accordance with an embodiment of the present invention, which illustrates a result when incorrect input is given to the embodiment of FIG. 5A;

FIG. 6A is a schematic of a program compiler module in accordance with an embodiment of the present invention;

FIG. 6B is a schematic in accordance with an embodiment of the present invention, which illustrates sample calls which may be used by the program compiler module of FIG. 6A;

FIG. 6C is a schematic in accordance with an embodiment of the present invention, which illustrates sample transformations which may be used by the program compiler module of FIG. 6A;

FIG. 7 is a flow diagram for transforming variables before compilation thereof into object code by a program compiler module shown in FIG. 6A, according to an embodiment of the present invention;

FIG. 8 is a flow diagram of an algebraic transformation of variables to create an automorphism in accordance with one embodiment of the present invention;

FIG. 9 is a graph of a program behavior after the transformation of FIG. 7, in accordance with one embodiment of the present invention;

FIG. 10 is an implementation of a standard encrypting algorithm, the RSA algorithm, before blackening; and

FIG. 11 is a blackened version of the source code depicted in FIG. 10, according to one embodiment of the invention.

### DETAILED DESCRIPTION

Various embodiments include program products comprising computer-readable, non-transient storage media for carrying or having computer-executable instructions or data structures stored thereon. Such non-transient media can be any available media that can be accessed by a general purpose or special purpose computer or server. By way of example, such non-transient storage media can comprise random-access memory (RAM), read-only memory (ROM), erasable programmable read-only memory (EPROM), electrically erasable programmable read-only memory (EEPROM), field programmable gate array (FPGA), flash memory, compact disk or other optical disk storage, magnetic disk storage or other magnetic storage devices, or any other medium which can be used to carry or store desired program code in the form of computer-executable instructions or data structures and which can be accessed by a general purpose or special purpose computer. Combinations of the above are also to be included within the scope of non-transient media. Volatile computer memory, non-volatile computer memory, and combinations of volatile and non-volatile computer memory are also to be included within the scope of non-transient storage media. Computer-executable instructions comprise, for example, instructions and data that cause a general-purpose computer, special purpose computer, or special purpose processing device to perform a certain function or group of functions.

In addition to a system, various embodiments are described in the general context of methods and/or processes, which is implemented in some embodiments by a program product including computer-executable instructions, such as program code, executed by computers in networked environments. The terms “method” and “process” are synonymous unless otherwise noted. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

In some embodiments, the method(s) and/or system(s) discussed throughout are operated in a networked environment using logical connections to one or more remote computers having processors. In some embodiments, logical connections include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like.

In some embodiments, the method(s) and/or system(s) discussed throughout are operated in distributed computing environments in which tasks are performed by local and remote processing devices that are linked (either by hardwired links, wireless links, or by a combination of hardwired or wireless links) through a communications network. In a distributed computing environment, according to some embodiments, program modules are located in both local and remote memory storage devices. In various embodiments, data are stored either in repositories and synchronized with a central warehouse optimized for queries and/or for reporting, or stored centrally in a database (e.g., dual use database) and/or the like.

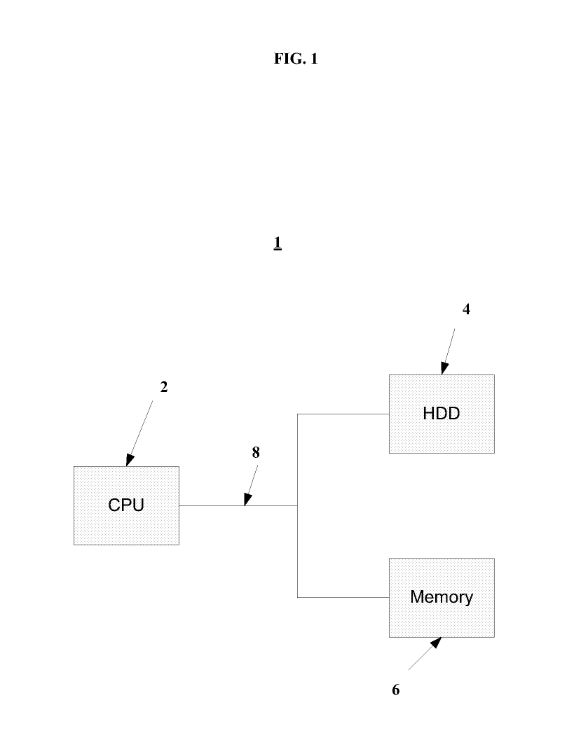

FIG. 1 illustrates a non-limiting system according to some embodiments of the present invention. As shown in FIG. 1, an exemplary system 1 for implementing the method(s) discussed include (but is not limited to) a general-purpose computing device in the form of a conventional computer, including a processing unit 2 or processor, a system memory 6, and a system bus 8 that couples various system components including the system memory 6 to the processing unit 2. The system memory 6 includes RAM as an example, but it is not limited that. The computer includes a storage medium 4, such as, but not limited to, a solid state storage device and/or a magnetic hard disk drive for reading from and writing to a magnetic hard disk, a magnetic disk drive for reading from or writing to a removable magnetic disk, and an optical disk drive for reading from or writing to removable optical disk such as a CD-RW or other optical media, flash memory, etc. The drives and their associated computer-readable media provides non-transient, non-volatile storage of computer-executable instructions, data structures, program modules, and other data for the computer.

Various embodiments employing software and/or Web implementations are accomplished with standard programming techniques with rule-based logic and other logic to accomplish the various database searching steps, correlation steps, comparison steps and decision steps. In addition, the words “component” or “module,” as used herein, encompass, for example, implementations using one or more lines of software code, hardware implementations, and/or equipment for receiving manual inputs.

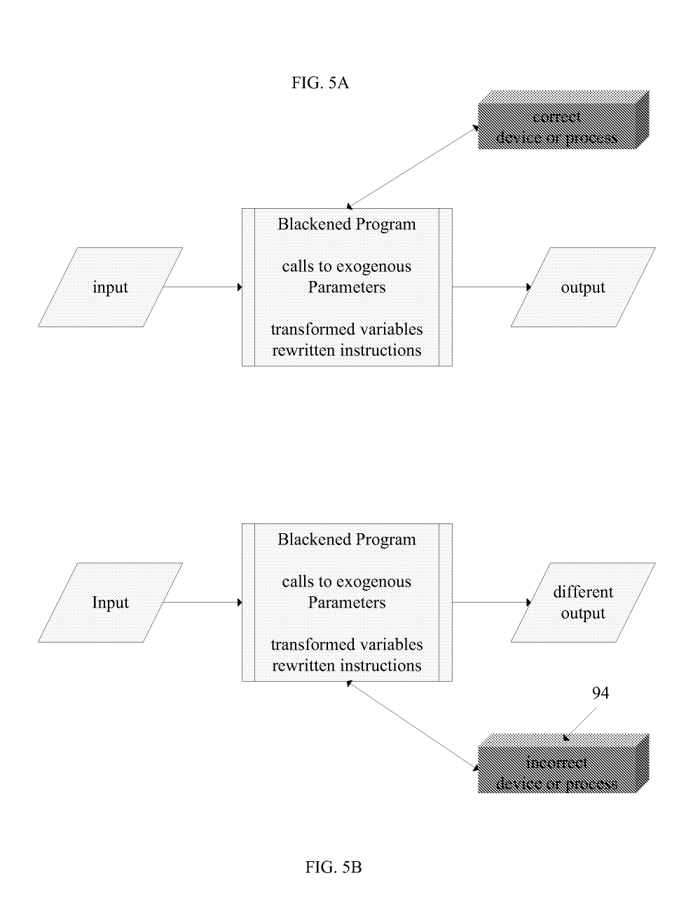

Embodiments of the present invention provide a method and system for increasing security of a computer program by obfuscation of portions of the computer-executable instructions. Such a method is referred to herein as “blackening.” In various embodiments, the computer system is configured to blacken or transform a program P, which have zero or more inputs and zero or more outputs, into a new program B(P) having inputs and outputs (if any) that are the same as the program P. Some embodiments can be implemented in such a way to allow, the program P and the new program B(P) to operate with comparable speeds and resource requirements. However, it may be computationally infeasible to decide whether the program P and the new program B(P) are equivalent, given only their source code. An overall effect of blackening according to one embodiment of the invention is illustrated in FIGS. 5A and 5B.

According to various embodiments, blackening can be thought of as a form of program obfuscation. One difference between some embodiments of the present invention and more conventional forms of program obfuscation is that the former is implemented so that the program will only execute “successfully” under very controlled circumstances. In contrast, most conventional obfuscation processes start with a program P, create a program O(P), and allow the program O(P) to execute with arbitrary input. Most theoretical discussions of program obfuscation assume that the obfuscated program will execute with arbitrary input, and usually conclude that it is very difficult or impossible to implement obfuscation in which the obfuscated program is not allowed to reveal much information about the original program.

Another difference between some embodiments of the present invention and conventional forms of program obfuscation is that the former exploits problems in mathematics that are known to be intractable to solve. Specifically, those mathematical problems include (but are not limited to): (i) deciding if a system of nonlinear algebraic equations have a solution; (ii) deciding if two systems of nonlinear algebraic equations are equivalent; (iii) parameterizing the solution sets of a system on nonlinear algebraic equations; or (iv) finding the Grobner basis of a polynomial ideal. An advantage of this is that it is much more difficult to analyze the blackened program using only the source code because most types of analysis depend on tools such as logic analyzers. However, such tools assume that the program can be executed successfully.

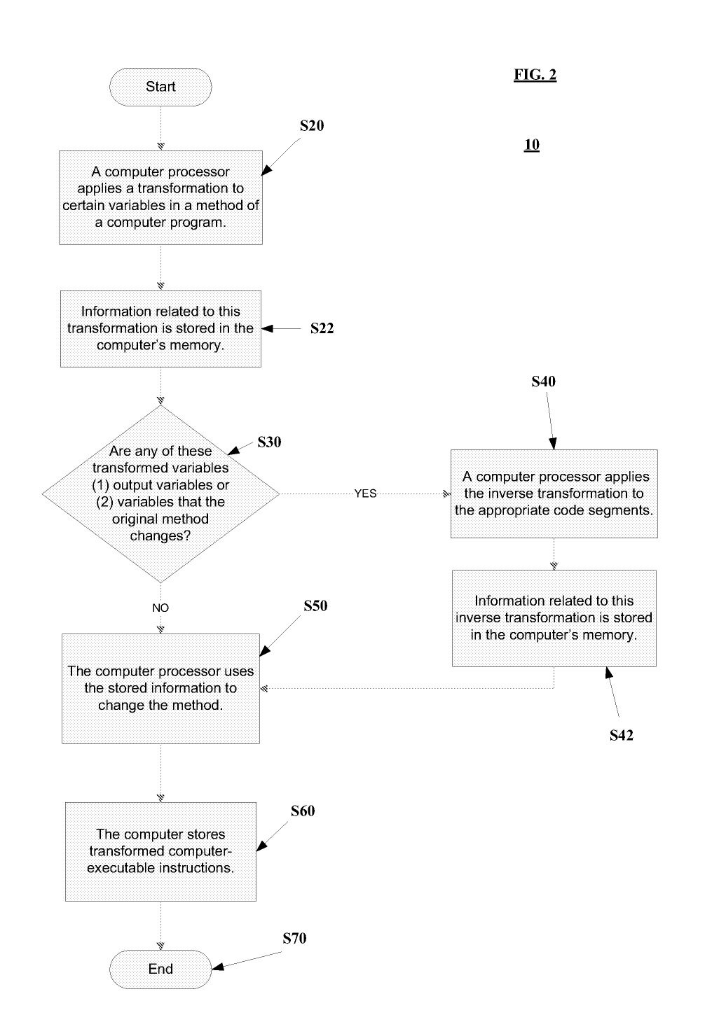

With reference to FIGS. 1 and 2, according to various embodiments, blackening is implemented by the computer system 1 according to process 10, but is not limited to process 10. First, in step S20, the processor 2 is configured to apply a transformation (as will be discussed) to value representation(s) of source code that is to be blackened. In various embodiments, a value representation is, for instance, a variable, constant, parameter, or any symbolic name that represents a value. In some embodiments, the value representation(s) are chosen by hand, for example, by a software engineer who is familiar with the source code. In other embodiments, the value representation(s) are chosen by a computer program. In some embodiments, in step S22, the processor 2 stores the transformation and/or its resulting code segments in, for example, the system memory 6 or the storage medium 4.

In step S30, the computer system 1 makes a determination whether the transformed values are output variables or variables that the original source code to be transformed changes.

In step S40, the processor 2 is configured to create a transformation that is an inverse of the transformation of step S20. In some embodiments, in step S42, the processor 2 stores the inverse transformation and/or its resulting code segments, for example, in the storage medium 4 or the system memory 6. According to a further embodiment of the invention described in FIG. 2, steps S40 and S42 are omitted.

For example, in some embodiments, the inverse transformation allows the transformation of some or all of the blackened output variable(s) to be reversed before they are returned or otherwise output from the blackened code. As such, the resulting output value(s) would then not be adversely affected by the obfuscation.

In further embodiments, the inverse transformation is used, for example, in parts of the code where the original source code itself changes the value of some or all of the value representation(s) to be blackened. Thus, the transformation is reversed using the inverse transformation, a desired value is changed, and then the transformation of step S20 is reapplied. In even further embodiments, the inverse transformation is used for both output value(s) as described in the previous paragraph and value(s) that the original source code itself changes.

In step S50, the processor 2 is configured to create source code instructions that reflect the transformation of the previous steps. Then in step S60, the processor 2 stores the resulting source code instructions, for example, in the system memory 6. In some embodiments, the original code is updated. In other embodiments, a separate representation of instructions of the original code is created or changed.

In some embodiments of the present invention, the transformation described above involves one or more linear transformations and/or one or more nonlinear transformations. In some embodiments, the transformation of value representation(s) is accomplished using a nonlinear transformation. In other embodiments, the transformation is accomplished using a function composition transformation. In a function composition transformation, the output of one or more function transformations is used as an input of one or more other function transformations. In further embodiments, the transformation involves an affine automorphism.

For example, a function composition transformation is, in some embodiments, a linear transformation of the value representation(s) composed with another linear transformation. In another example, the function composition transformation is a linear transformation, composed with a nonlinear transformation. In still another example, the function composition transformation is a nonlinear transformation composed with a linear transformation. In other embodiments, the function composition transformation is any number of nonlinear and/or linear transformations composed together. For example, the function composition transformation is, in some embodiments, a linear transformation composed with a nonlinear transformation composed with a nonlinear transformation.

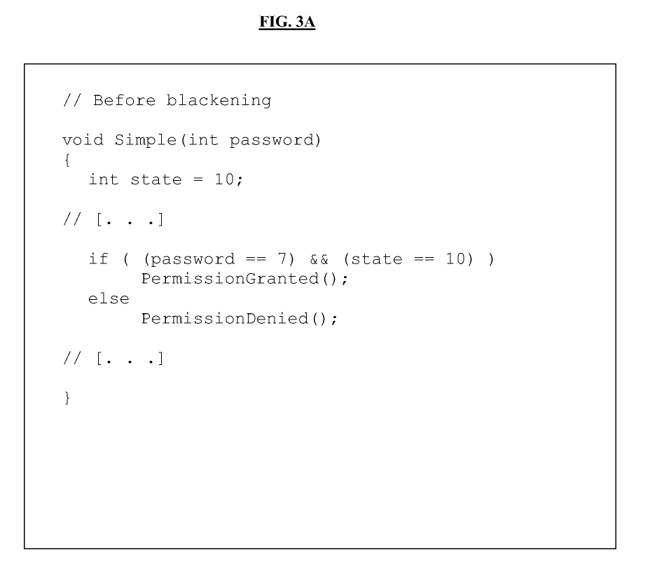

To illustrate how a transformation is performed according to some embodiments, consider a program P that has two variables to be blackened, x and y. These variables map to a new coordinate system defined by u=x and v=y+F(x), for instance. Thus, the transformation of variable y is dependent on variable x. The effect of this transformation is shown by comparing FIG. 3A (pre-blackening) and FIG. 3B (post-blackening). Code segments in the method named Simple( ) in FIG. 3B have been transformed using, as an example, the function, F(x)=x²+x+2. Code segments related to the variables named “state” and “password,” have been replaced with transformed code segments using the new coordinate system variables, “u” and “v.” That is, “state” has been replaced directly with “u” because, in the new coordinate system, x=state=u.

Additionally, “password” has been replaced with code segments that correspond with the applied transformation. The transformation in this case is obtained by solving for variable y in the relevant coordinate system equation, y=v−F(x):

y=password=v−u²−u−2.

The code segments in the Simple( ) method have been mathematically simplified in FIG. 3B in order to mask the transformation that was used. In further embodiments, the simplifying of code segments are omitted. As shown in FIGS. 3A and 3B, a PermissionGranted( ) call in the Simple( ) method is called only if password is equal to 7 and the state/u variable is equal to 10, both before and after blackening.

In some embodiments, additional layers of complexity is added to the data transformation to produce obfuscated code that is more difficult to reverse engineer. For example, in some embodiments, one function transformation is composed with another function transformation. To illustrate this, consider a program P with three variables to blacken, x, y, and z. In this example, these variables map to a new coordinate system defined by u=x, v=y+F(x), and w=z+G(x, y), for instance. Solving for variables x, y, and z:

x=u;

y=v−F(u);

z=w−G(u,v−F(u)).

Thus, in that example, the transformation of variable y is dependent on variable x, and the transformation of variable z is dependent on both variables x and y. In embodiments such as this, the transformation is dependent on all of the affected value representation(s). In other embodiments, the transformation involves multiple transformations over subsets of the value representation(s). One example involves a nonlinear transformation over one set of variable(s), and a separate function composition transformation over a different set of variable(s), such that one is not dependent on the other. In other embodiments, one or more transformations are dependent on one or more different transformations. In one example, the result of a nonlinear transformation over a first variable is used as input for a function composition transformation. In this case, the value of the first variable affects the blackened value of other variable(s).

Transformations according to some embodiments of the present invention can create very complicated source code, which may make the code more difficult to reverse engineer. Other variations on the transformations are described in the disclosure, and still other variations would be apparent to those skilled in the art.

The mathematical model of the transformation, according to some embodiments involving the blackening of value representations of integers, can be described as follows. This blackening process starts with a program P, which can be thought of as: (1) A set of integer-valued input variables z=(z₁, . . . , zₖ). (2) A set of integer-valued state or accumulator variables x=(x₁, . . . , xₙ). (3) A set of integer-valued output variables y=(y₁, . . . , yₗ). (4) A series of computation instructions {α₁, . . . } that perform the operation x←F_{α}(x), with F_{α}(x) a polynomial mapping in which the coefficients are in the integers. (5) A series of decision instructions {β₁, . . . } that decide which instruction to perform next based on the sign of some polynomial G_{β}(x). (6) Maps in, out, from z to x and x to y.

There are many one-to-one and onto polynomial mappings of the set of all integer n-tuples to itself. These functions are algebraic automorphisms and the set of all such functions will be denoted by Aut(n). This is thought to be a very large nonabelian group that consists mostly of nonlinear functions. The group Aut(n) has a structure which may not currently be understood. Even deciding whether a polynomial mapping of n-tuples is an element of Aut(n) may not be well understood. There may not currently be an algorithm known for finding the inverse of an arbitrary element of Aut(n).

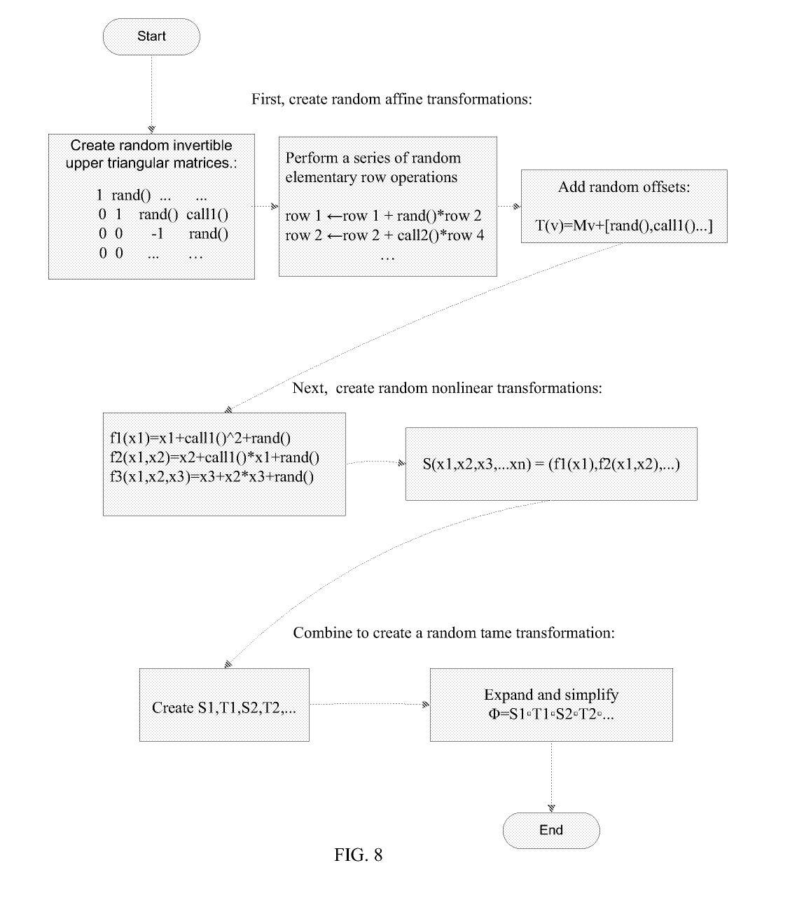

One way to generate elements of Aut(n) is to produce “tame” automorphisms. The generation of tame automorphisms is illustrated in FIG. 8. Tame automorphisms are compositions of simpler automorphisms of the form φ=Sₘ∘Tₘ∘ . . . ∘S₁∘T₁ in which the mappings Tᵢ are affine automorphisms, i.e. an invertible linear mapping along with some constant offset. The other mappings are the ones that add nonlinearity to the composition. They are of the form,

S(x₁, . . . , xₙ)=(x₁+ƒ₁(x₂, . . . , xₙ), x₂+ƒ₂(x₃, . . . , xₙ), . . . , xₙ₋₁+ƒₙ₋₁(xₙ), xₙ+ƒₙ).

Here, the functions ƒᵢ(xᵢ₊₁, . . . , xₙ) are polynomials in the indicated variables. It is thought that every element of Aut(n) can be produced in such a manner. Given a decomposition of automorphisms as above, the inversion is produced by inverting each piece of the composition and then composing those inversions in reverse order. Inverting the affine transformations can be implemented by inverting a linear mapping. Inverting the nonlinear mappings is given by a simple recursive procedure: If (y₁, . . . , yₙ)=S(x₁, . . . , xₙ), then one can solve for xₙ, xₙ₋₁, . . . (in reverse order) by:

$${x}_{n} = {y}_{n} - {f}_{n} ;$$

$${x}_{n - 1} = {y}_{n - 1 -} {f}_{n - 1} ( {x}_{n} ) ;$$

$${x}_{n - 2} = {y}_{n - 2 -} {f}_{n - 2} ( {x}_{n - 1} , {x}_{n} ) ;$$

$$…$$

$${x}_{1} = {y}_{1 -} {f}_{1} ( {x}_{2} , … , {x}_{n} ) .$$

The following is a more detailed, but non-limiting, description of how to implement blackening according to some embodiments of the invention. Start with a program P and a set of exogenous integer-valued parameters that will control whether a new program B(P) can be executed. These parameters are denoted here as θ=(θ₁, . . . , θₚ). In various embodiments, the processor 2 is configured so that parameter values will be obtained by calls to utility functions such as, but not limited to, the Intel® Processor Identification Utility or GPS Utility 4.5. These calls are denoted here as call₁( ), . . . , callₚ( ). In this example, callᵢ( ) is meant to return a value of θᵢ=tᵢ. That is to say, the new program B(P) should only execute if callᵢ( )=tᵢ for i=1, . . . , p. Assume that p>1.

Next, create a mapping Φ from parameter values θ to Aut(n). This is done, e.g., by the processor 2, by generating random polynomials ƒᵢⱼ(xᵢ₊₁, . . . , xₙ; θ) in the variables xᵢ₊₁, . . . , xₙ so that the coefficients depend on the parameters θ. Define nonlinear transformations Sⱼ(θ) that depend on θ so that:

Sⱼ(θ):(x₁, . . . , xₙ)→(x₁+ƒ₁ⱼ(x₂, . . . , xₙ;θ), x₂+ƒ₂ⱼ(x₃, . . . , xₙ;θ), . . . , xₙ₋₁+ƒₙ₋₁ⱼ(xₙ;θ), xₙ+ƒₙ(θ)).

Generate random invertible families of affine transformations T₁(θ), . . . , Tₘ(θ) on the variables (x₁, . . . , xₙ) that are parameterized by θ. The mapping Φ(θ) is then:

Φ:θ→Sₘ(θ)∘Tₘ(θ)∘ . . . ∘S₁(θ)∘T₁(θ).

Find another mapping Ψ from parameter values θ to Aut(n) as follows. To do this, pick a random positive number q<p. Pick q random pairs (i(1), j(1)), . . . , (i(k),j(k)) with 0≦i≦n and 1≦j≦m. For each random pair, generate random polynomials gᵢⱼ(X₁, . . . , Xₚ) in p variables without a constant term so that gᵢⱼ(0, . . . , 0)=0. For all other pairs in the range 0≦i≦n and 1≦j≦m set gᵢⱼ(X₁, . . . , Xₘ)=0. Define the polynomials as:

hᵢⱼ(xᵢ₊₁, . . . , xₙ;θ)=gᵢⱼ(θ₁−t₁, . . . , θₚ−tₚ)+ƒᵢⱼ(xᵢ₊₁, . . . , xₙ;t₁, . . . , tₘ).

By construction, hᵢⱼ(xᵢ₊₁, . . . , xₙ; t)=ƒᵢⱼ(xᵢ₊₁, . . . , xₙ; t) for all i,j. However, for θ with θ≠t, it is the case that hᵢⱼ(xᵢ₊₁, . . . , xₙ; θ)≠ƒᵢⱼ(xᵢ₊₁, . . . , xₙ; θ).

As before, define nonlinear transformations of (x₁, . . . , xₙ) that depend on θ by:

S′ⱼ(θ):x→(x₁+h₁ⱼ(x₂, . . . , xₙ;θ), x₂+h₂ⱼ(x₃, . . . , xₙ;θ), . . . , xₙ₋₁+hₙ₋₁ⱼ(xₙ;θ), xₙ+hₙⱼ(θ)).

These new nonlinear transformations have the property that S′ⱼ(t)=Sⱼ(t) and S′ⱼ(θ)≠Sⱼ(θ) if θ≠t. Similarly define other families of affine transformations T′ⱼ(θ) with the properties that T′ⱼ(t)=Tⱼ(t) and T′ⱼ(θ)≠Tⱼ(θ) if θ≠t.

Invert the transformation S′ₘ(θ)∘T′ₘ(θ)∘ . . . ∘S′₁(θ)∘T′₁(θ) by inverting each transformation individually, and then compose them all to obtain Ψ(θ). Note that Ψ(t) is the inverse of Φ(t), but if θ≠t, then Ψ(θ) is not the inverse of Φ(θ). This follows from the constructions above.

Returning to the program P, the nonlinear mappings Φ(θ) and Ψ(θ) will be used to perform a rewrite of algebraic expressions in the instruction set of the program P as follows. (I) The computation instruction x←F_{α}(x) is replaced by the instruction u←Ψ(F_{α}(Φ(u; θ)); θ) with u=(u₁, . . . , uₙ). In the case that θ=t, these instructions are equivalent after the substitutions u=Φ(x; t) and x=Ψ(u; t). However, if θ≠t, these instructions are not equivalent.

(II) The instruction deciding which instruction to perform next based on the sign of a polynomial G_{β}(x) is replaced by the instruction deciding which instruction to perform next based on the sign of the polynomial G_{β}(Ψ(u; θ)). In the case that θ=t, these instructions are equivalent after the substitutions u=Φ(x; t) and x=Ψ(u; t). However, if θ≠t, these instructions are not equivalent.

(III) The operations x←in(z), y←out(x) are replaced by the operations u←Φ(in(z); θ) and y←out(Ψ(u; θ)). Then, the new program B(P) is the result of these modifications along with (IV) the replacement of the variables x₁, . . . , xₙ by u₁, . . . , uₙ; (V) the addition of new variables θ₁, . . . , θₚ; and (VI) the insertion of the operations θ₁←call₁( ), . . . , θₚ←callₚ( ). Thus, the program P and the new program B(P) are equivalent if θ=t, but not if θ≠t. Hence, the new program B(P) will only execute properly if t₁=call₁( ), . . . , tₚ=callₚ( ).

In order to recover the program P from the new program B(P) (i.e., to undo the blackening process), one can obtain x from u, F_{α} from Ψ(F_{α}(Φ(u; θ)); θ) and G_{β} from G_{β}(Ψ(u; θ)). There are several possible processes for doing this.

One example process is to find t directly, e.g., obtain it from someone who knows the secret value, or from a device on which the secret value is stored. Use this in place of the operations θ₁←call₁( ), . . . , θₚ←callₚ( ). This may not allow an analysis of the new program B(P) directly, though the new program B(P) can be forced to execute. One can then attack the new program B(P) with logic analyzers, etc. However, even if t is known, trying to recover the program P from the new program B(P) can be very difficult, in general. One method is to recover the polynomial functions F_{α} from Ψ(F_{α}(Φ(u; t)); t). But, in general, no algorithm is thought to exist that determines whether two different systems of polynomial equations in many integer variables are equivalent. Practically, then, recovering the program P from the new program B(P) is believed to be very difficult without also knowing Φ(u; t) and Ψ(u; t), which are not part of the new program B(P). Keeping these functions as part of a private key means that even if t is found, it is believed to be very difficult to create a general algorithm to recover the program P.

Another example process is to try to find t by brute force and then proceed as above. To do this, one can continuously try to run the new program B(P) with different guesses of what t might be, and stop when the new program B(P) is thought to run correctly. Alternatively, one can try running pieces of the new program B(P) with different guesses of what t might be, as discussed below. However, the discussion above still applies.

Yet another example process is to find Φ(u; θ) and Ψ(u; θ) from the u←instructions Φ(in(z); θ), y←out(Ψ(u; θ)) and then use these to solve for t. To solve u for t from Φ(u; θ) and Ψ(u; θ), one may ultimately have to solve the system of equations gᵢⱼ(θ₁-t₁, . . . , θₚ-tₚ)=0, since these are the terms that are at the heart of the generation of Ψ from Φ and are responsible for the difference between Ψ and Φ⁻¹. This is a system of q Diophantine equations in p unknowns with q<p. Matiyasevich's theorem implies that it is not possible to create a general algorithm that can decide whether a given system of Diophantine equations has a solution among the integers.

Yet another example process is try to find Φ(u; θ) and Ψ(u; θ) and their inverses directly without finding t. Once again, this is thought to be very difficult mathematically, without knowing the functions involved. Even if those functions are known, there may be no algorithm which, in general, will find the inverse of Φ(u; θ) from Φ(u; θ) or the inverse of Ψ(u; θ) from Φ(u; θ). It is possible that the best that one can do is attempt to find the factors T₁, . . . , Tₘ and S₁, . . . , Sₘ so that Φ(u; θ)=Sₘ(θ)∘Tₘ∘ . . . ∘S₁(θ)∘T₁ and then using this to perform the inversion. However, it is thought that it would be very difficult to find an algorithm other than brute force that can perform this factorization.

Yet another example process is to try to recover F_{α} directly from Ψ(F_{α}(Φ(u; θ)); θ) and G_{β} from G_{β}(Ψ(u; θ)). This is thought to be very difficult, in general, without knowing Φ(u; θ) and Ψ(u; θ).

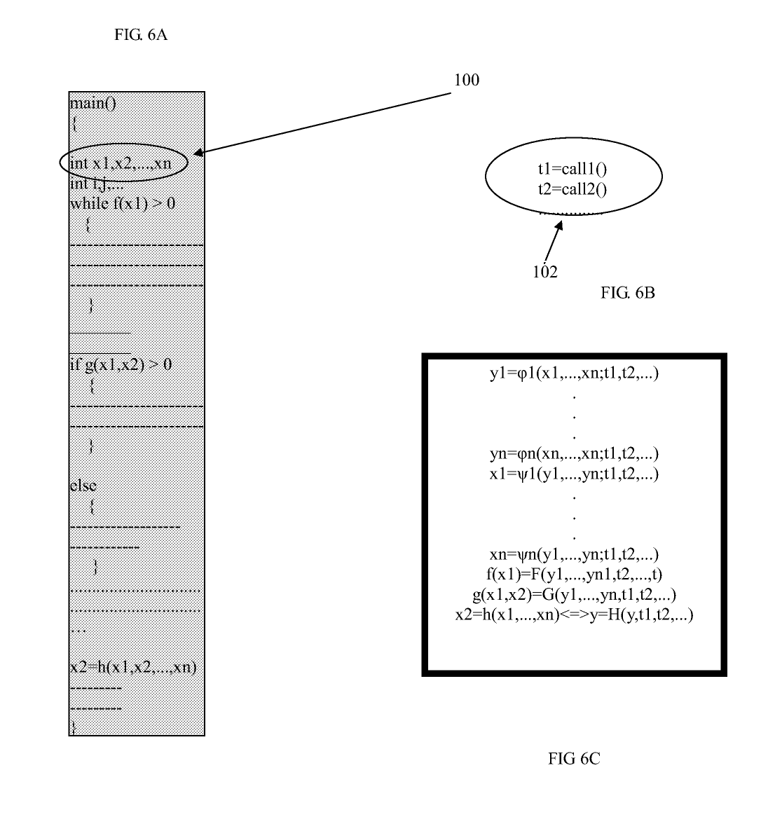

In some embodiments of the present invention, a blackening process is implemented by the computer system 1 (refer to FIG. 1) according to, but not limited to, the process of FIGS. 2 and 4A-9. With reference to FIGS. 2, 6A, and 6B, first, all variables, constants, parameters in a program to be blackened 100 are identified. The values of exogenous parameters to be satisfied 102 are obtained for the blackened program to allow successful execution or execution through the protected code path. Constant declarations are replaced by variable declarations.

To accomplish the above, some embodiments include the use of an analyzer. For example, a dynamic analyzer is used in some embodiments, in which at least the relevant part of the program runs with random, but typical, inputs. Some embodiments further involve a user interface that allows an operator or automated agent to insert desired external variables, states, and actions into the code. In some embodiments, an analyzer uses a heuristic to select a region of the code to transform. In some embodiments, the analyzer efficiently processes large code sets using a flow analysis engine to identify the selected regions in which selected variables are used or not used to develop reports on predicted behavior and performance. In some embodiments, a frequency table that tracks which variables are accessed or modified during these random runs is created and analyzed. In other embodiments, an analyzer determines which value representations will be blackened by inspecting the source code rather than executing it. In some embodiments, functions or processes to be called in the event of unauthorized use of the software is determined or created.

In still other embodiments, those familiar with the source code are conferred with or notes may be received from them to determine typical inputs and situations for execution of the program, and/or to determine what functions or processes should be called in the event of unauthorized use of the software. In other embodiments, the source code itself or comments left in the source code may be inspected to make those determinations.

Second, transformations are selected, generated, and applied to the selected variables, constants and parameters. An example transformation is illustrated in FIG. 6C. In various embodiments, this is done by a processor 2 of the computer system 1. The number of invertible affine transformations and invertible nonlinear transformations are chosen that will be composed together to obtain the automorphism of the set of chosen variables employed by the blackening process. Some embodiments involve a toolset that generates code transformation algorithms and equations that can automatically be applied to segments of source code. The number of affine transformations used is one more than the number of nonlinear transformations used. All of these transformations act on the set of variables chosen in the previous step.

To generate an affine transformation, a random number generator is used to create a random upper-triangular matrix with diagonal entries all equal to +/−1. Nonzero, non-diagonal elements are randomly chosen. Either a call to a randomly-chosen exogenous parameter or the value that the call to that parameter must return to allow the executable to perform correctly is replaced by those randomly-chosen elements. Then, a series of randomly-generated elementary row operations is applied to the random upper-triangular matrix. Some coefficients in the row operations is randomly chosen. Either a call to a randomly-chosen exogenous parameter or the value that the call to that parameter must return to allow the executable to perform correctly is replaced by those randomly-chosen coefficients. The resulting matrix is then invertible over the integers. Next, a series of random integer offsets is chosen. Either a call to a randomly-chosen exogenous parameter or the value that the call to that parameter must return to allow the executable to perform correctly is replaced by some of those random integer offsets. The resulting matrix is then invertible over the integers. Each affine transformation is then the composition of an offset together with multiplication by one of the randomly-generated integral, invertible matrices. Each affine transformation is stored on non-transient storage media 4, 6 of a computer system 1.

To generate the invertible nonlinear transformations, the variables that are to be blackened are listed. For each variable on the list, a random number generator is used to create a polynomial that is that variable plus a random polynomial in the variables succeeding that variable. Some coefficients in the polynomials are randomly chosen. Either a call to a randomly-chosen exogenous parameter or the value that the call to that parameter must return to allow the executable to perform correctly is replaced by those coefficients. Each nonlinear transformation is then composed of these polynomial maps in the manner described in the previous section. The resulting transformation is stored on non-transient storage media 4, 6 of a computer system 1.

The automorphism of the variables that have been chosen to be rewritten is created. To do this, all of the affine and nonlinear transformations are collected. A symbolic mathematical engine is employed to expand and simplify the polynomials resulting from the composition of these transformations. The result is stored on non-transient storage media 4, 6 of a computer system 1.

Third, the inverse of the transformations is created. In various embodiments, this is done by a processor 2 of the computer system 1. To create the inverse of an affine transformation, refer the sequence of offsets, triangular matrices, and row operations used in its creation is referred to in order to generate the inverse of each affine transformation. These inverses are stored on non-transient storage media 4, 6 of a computer system 1.

To create the inverse of a nonlinear transformation, the recursive formula described in the previous section is applied to the polynomials generated to create the nonlinear transformation. To do this, a symbolic mathematical engine is employed to expand and simplify the resulting polynomials. The resulting transformations is stored on non-transient storage media 4, 6 of a computer system 1.

The inverse to the automorphism previously created is created. This is done by collecting all inverse affine transformations and nonlinear transformations. A symbolic mathematical engine is employed to expand and simplify the resulting polynomials. This result is stored on non-transient storage media 4, 6 of a computer system 1.

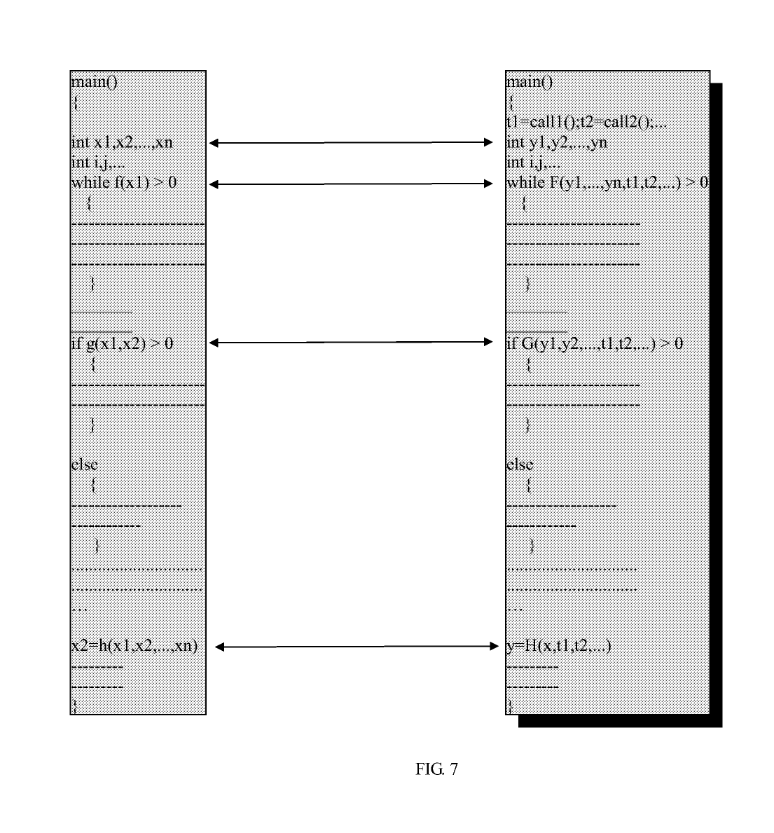

Fourth, the relevant sections is replaced in the source code with code segments that correspond with the above transformations. This is illustrated in FIG. 7, in which f(x1) is replaced by F(y1, . . . , yn, t1, t2, . . . ), g(x1, x2) is replaced by G(y1, y2, . . . , t1, t2, . . . ), and h(x1, x2, . . . , xn) is replaced by H(x, t1, t2, . . . ). In various embodiments, this is done by a processor 2 of the computer system 1. The result is stored on non-transient storage media 4, 6 of a computer system 1.

To do this, the source code is scanned for all input statements in the original source code that directly effect any selected variables. These statements are rewritten in terms of the new variables by using the transformation as described in part (III) above. The source code is scanned for all commands that alter the values of the selected variables. The commands are rewritten in terms of the new variables by using the transformation as described in part (I) above. In some embodiments, additional variables are incorporated into the transformation to enable control of the execution functions of the resulting executable code. The source code is scanned for all conditional statements involving any selected variables. These statements are rewritten in terms of the new variables by using the transformation as described in part (II) above. The source code is scanned for all commands that alter the values of unselected variables using values of selected variables. The commands are rewritten in terms of the new variables by using the transformation as described in part (I). The source code is scanned for all commands that output values using expressions dependent on values of selected variables. These commands are rewritten in terms of the new variables by using the transformation as described in part (III).

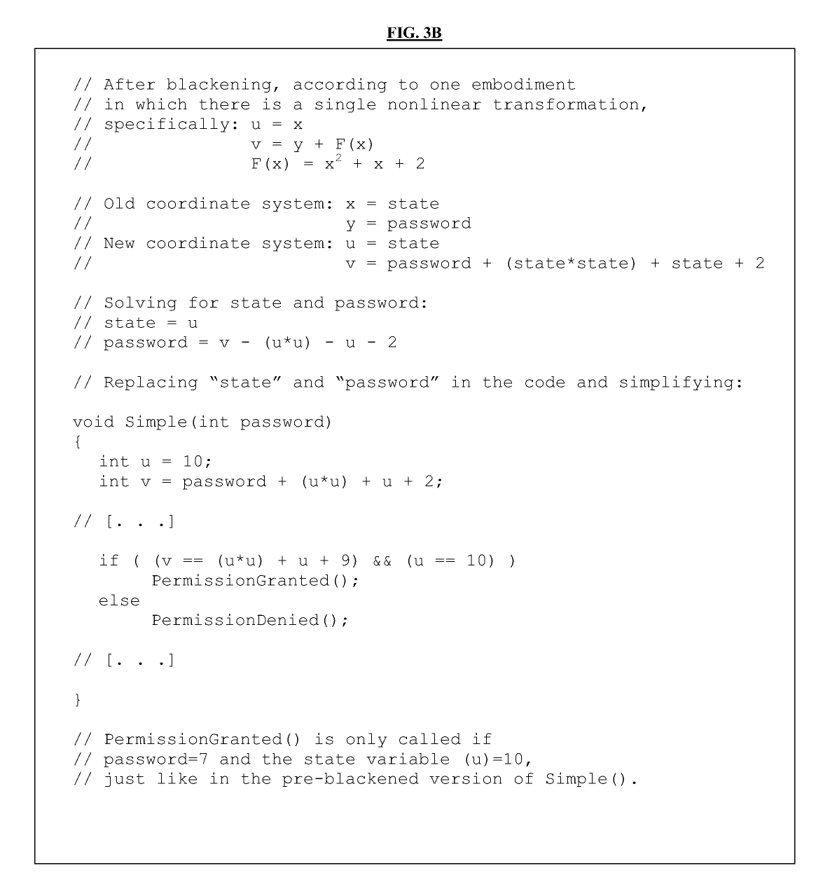

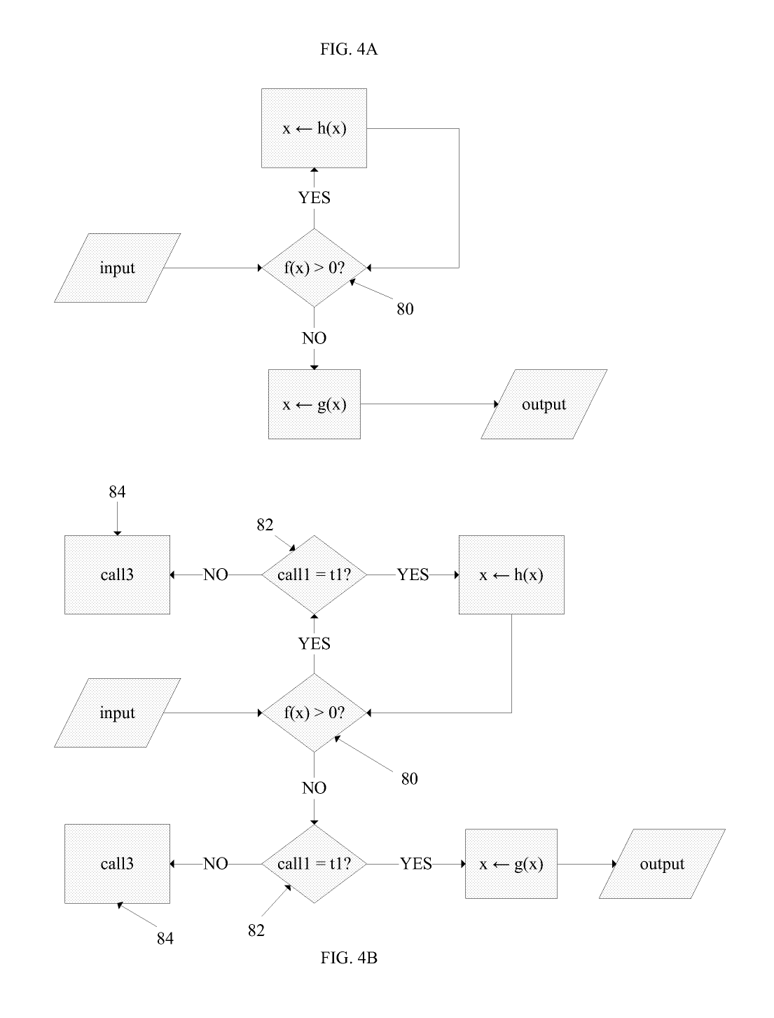

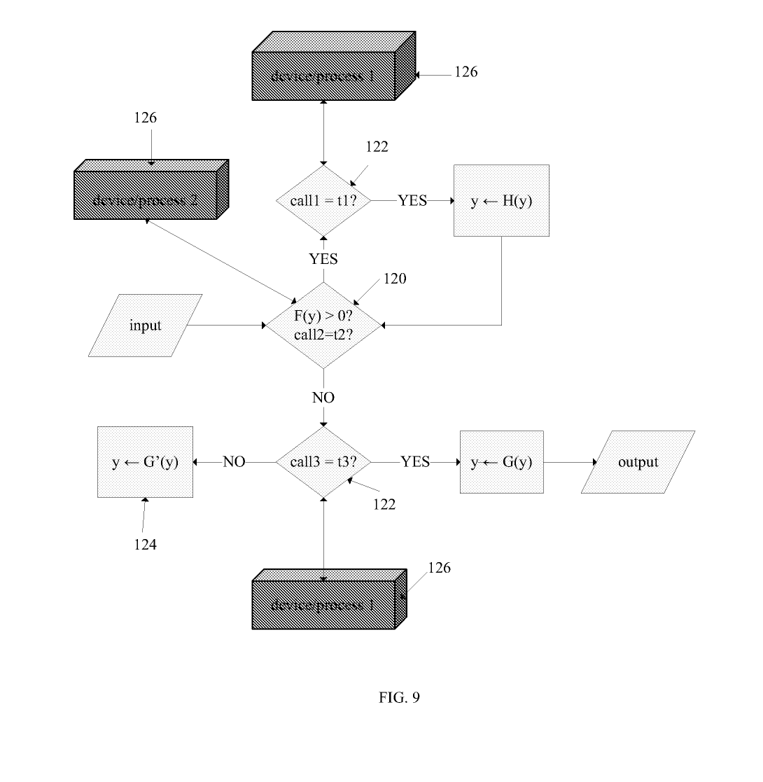

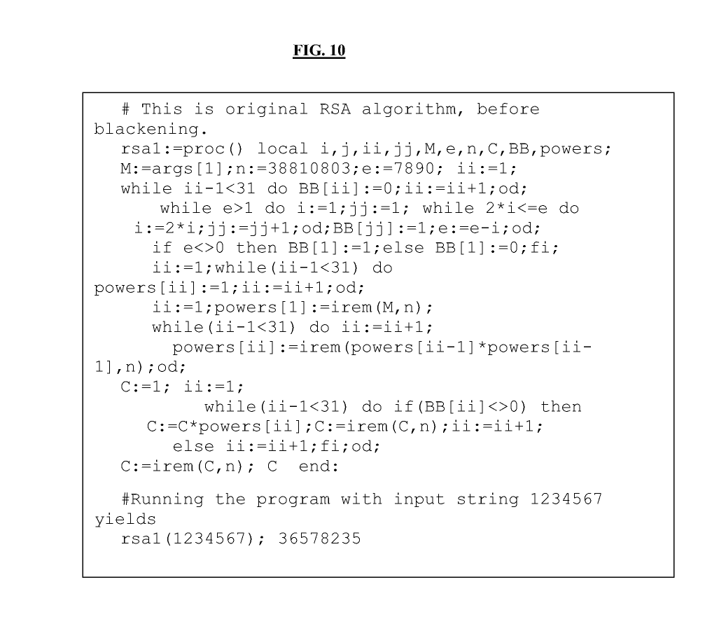

Additionally, authentication calls 82, 122 are added to the devices or processes 126 that supply the correct values of the exogenous parameters that were selected previously. If all authentication calls 82, 122 to the appropriate devices and processes 126 are correct, the blackened program will behave exactly like the original program. If the authentication calls 82, 122 do not return the correct values, the program will not perform like the original program. Example authentication calls 82, 122 are illustrated in FIGS. 4B and 9. Decision points 80, 120 are inserted into the program that invoke these functions and process authentication calls 82, 122 if the program is used in an unauthorized manner. Example decision points 80, 120 are illustrated in FIGS. 4A, 4B, and 9. The result of unauthorized use is illustrated in FIG. 5B, to be contrasted with the result of authorized use, which is illustrated in FIG. 5A.

In some embodiments, as illustrated by FIGS. 4B, 5B, and 9, behavior may be specified for the event that the authentication call 82, 122 returns incorrect data. In some embodiments, for example, code segments or calls to devices or processes 84, 94, 124 are added to the new program B(P) that perform operations of no value or clear purpose, yet it is difficult to decode their purpose or non-purpose.

In some embodiments, additional heuristics are used to limit the amount of the blackened code depending upon the desirable performance level. Based on another heuristic, in the variable pairing process, compilation-unique differences, i.e., differences across from one compilation to another compilation are introduced. In addition, diffusion is be added via yet another heuristic, assisting in propagation of undesired data tampering. In some embodiments, the diffusion entails, for example, improving the chance that a new variable will be selected for different variable reference partners across compilations rather than selection of the same pair over again.

In some embodiments, blackening is used on code that will be compiled. In some such embodiments, the transformation is performed by pre-compiler software. In other embodiments, blackening is used on code that will not be compiled, such as interpreted code.

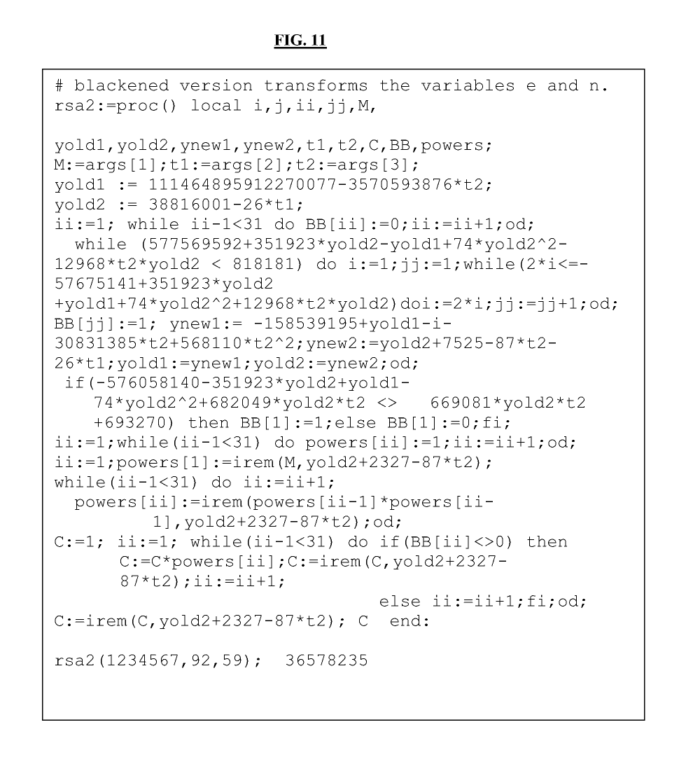

One exemplary application of blackening is cryptographic systems. FIG. 10 is an implementation of a sample encryption algorithm, the RSA algorithm, before blackening. FIG. 11 is a blackened version of the same algorithm, according to one embodiment of the invention.

Applying blackening to standard encryption algorithms could, for instance, create cryptographic systems that do not require the use of passwords in the conventional sense. Instead, the passwords normally required of the encryption/decryption process would be supplied by calls to other processes. Examples of calls include, but are not limited to, central processor identification schemes, clocks, biometric sensors, GPS units, etc. The result would be a cyber security system which was controlled by situations such as what machine the encrypting/decryption processes was running, who was using the system, where or when the encrypting/decrypting process was occurring, etc. For example, blackening could be implemented so that a program would not successfully execute unless a call to a GPS unit of the computer system reports it is in a certain allowed location. For another example, blackening could be implemented so that the program will only successfully run on a certain computer, by performing a call to the computer system that returns the computer's unique identifier and then verifying that it matches a computer identifier from an authorized system. In yet another example, blackening could be implemented so that the program authenticates the user by only executing code successfully if a call to fingerprint reading device returns approved fingerprint data. In still another example, blackening could be implemented so that the program will only successfully run if a call to fetch the current time or date returns an allowed time or date.

Other examples of applications for content protection include copy protection for software, conditional access to devices (e.g., set-top boxes for satellite television and video on-demand) and applications that involve distribution control for protected content playback. Some examples of content protection involve software-based cryptographic content protection for Internet media distribution, including electronic books, music, and video.

Some embodiments of the present invention are for purposes other than source code obfuscation. For example, embodiments of the present invention are for obfuscation of data outside the context of computer-executable instructions.

Other embodiments of the present invention are for encryption of data that, for example, is stored on non-transient storage media of a computer system. A data transformation is applied to the data by, for example, a processor of the computer system. This results in transformed data that is stored alone on non-transient storage media of the computer system. In other embodiments, the transformed data replaces the original data stored on non-transient storage media. In some embodiments, the data transformation is, for example, a nonlinear transformation. In other embodiments, the data transformation is, for example, a function composition transformation. In various embodiments, the transformation is invertible to allow the data to be unencrypted using the inverse of the data transformation.

Some embodiments of the present invention use just one processor of a computer system. Other embodiments use multiple processors. In some embodiments involving multiple processors, the processors are in the same computer. In other embodiments, the processors are in more than one computer. In some embodiments, one processor executes part of the obfuscation or encryption while other processor(s) execute the rest.

Embodiments of the present invention generally relate to methods and systems for increasing security of a computer program. Although embodiments of the present invention are generally presented in the context of increasing software security by obfuscation of portions of its source code, various modifications will be readily apparent to those with ordinary skill in the art and the generic principles herein may be applied to other embodiments. Software or hardware, for instance, could incorporate the features described herein and that embodiment would be within the spirit and scope of the present invention. Additionally, systems and methods that encrypt or otherwise disguise data could incorporate the features described in the disclosure. Thus, the present invention is not intended to be limited to the embodiments shown, but is to be accorded the broadest scope consistent with the principles and features described herein.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed is:

1. A method for modifying one or more selected portions of computer-executable instructions stored on non-transient storage media of a computer system, the method comprising:
applying, with a processor of the computer system, a data transformation to one or more value representations in the computer-executable instructions to create one or more transformed code segments, said data transformation comprising at least one of a nonlinear transformation and a function composition transformation;
generating transformed computer-executable instructions based on said transformed code segments; and
storing said one or more transformed code segments with corresponding computer-executable instructions on the non-transient storage media.

2. The method of claim 1, wherein the transformed computer-executable instructions are generated by the processor of the computer system.

3. The method of claim 1, wherein said data transformation comprises a nonlinear transformation.

4. The method of claim 1, wherein said data transformation comprises a function composition transformation.

5. The method of claim 4, further comprising:
selecting, with said processor of the computer system, said one or more value representations.

6. The method of claim 5, wherein selecting said one or more value representations comprises analyzing, with said processor of the computer system, the computer-executable instructions to determine said one or more value representations.

7. The method of claim 4, further comprising:
reversing said data transformation in one or more of said transformed code segments by applying an inverse transformation of said data transformation.

8. The method of claim 4, wherein said function composition transformation is automorphic.

9. The method of claim 8, wherein said function composition transformation comprises at least one nonlinear function and at least two linear functions; and
wherein a number of said at least two linear functions is at least one more than a number of said at least one nonlinear functions.

10. The method of claim 9, further comprising:
reversing said data transformation in one or more of said transformed code segments by applying the inverse transformation of said data transformation.

11. A system for modifying one or more selected portions of computer-executable instructions, the system comprising:
a storage medium for storing computer-executable instructions; and
a processor configured to apply a data transformation to one or more value representations in the computer-executable instructions to create transformed source code segments, said data transformation comprising at least one of a nonlinear transformation and a function composition transformation;
said processor configured to create transformed computer-executable instructions based on said transformed source code segments;
said processor configured to store said transformed computer-executable instructions on a storage medium.

12. The system of claim 11, wherein said transformed computer-executable instructions and the computer-executable instructions are stored in the same storage medium.

13. The system of claim 11, wherein said data transformation comprises a nonlinear transformation.

14. The system of claim 11, wherein said data transformation comprises a function composition transformation.

15. The system of claim 14, wherein said processor is configured to select said one or more value representations.

16. The system of claim 14, wherein said processor is configured to generate an inverse transformation of said data transformation, said processor configured to apply said inverse transformation to one or more value representations in the computer-executable instructions to create inversely transformed source code segments.

17. The system of claim 14, wherein said function composition transformation is automorphic.

18. The method of claim 17, wherein said function composition transformation comprises one more linear functions than the number of nonlinear functions.

19. The system of claim 18, wherein said processor is configured to generate the inverse transformation of said data transformation that can be applied to source code segments.

20. A method for modifying one or more portions of data stored on non-transient storage media of a computer system, the method comprising:
generating, with a processor of the computer system, a data transformation to the one or more portions of data to create one or more transformed data segments, said data transformation comprising at least one of a nonlinear transformation and a function composition transformation;
creating, with said processor of the computer system, transformed data based on said transformed data segments; and
storing said transformed data on the non-transient storage media.

21. A system for executing a modified set of computer-executable instructions stored on non-transient storage media of a computer system, the system comprising:
a storage medium that contains the computer-executable instructions; and
a processor configured to execute the computer-executable instructions;
wherein the computer-executable instructions have been modified by a data transformation to one or more value representations in the computer-executable instructions;
wherein said data transformation comprised at least one of a nonlinear transformation and a function composition transformation.
